(19) United States
(12) Patent Application Publication
(10) Pub. No.: US 2026/0222880 A1
(43) Pub. Date: Jul. 30, 2026

(54) COMMUNICATION MODULE, METHOD OF OPERATING THE SAME, AND ELECTRONIC DEVICE

(71) Applicant: SAMSUNG ELECTRONICS CO., LTD., Suwon-si (KR)

(72) Inventors: Seonghwan HYUN, Suwon-si (KR); Dahae CHONG, Suwon-si (KR); Kiil KIM, Suwon-si (KR); Yeongjun KIM, Suwon-si (KR); Beomkon KIM, Suwon-si (KR); Joohyun DO, Suwon-si (KR)

(73) Assignee: SAMSUNG ELECTRONICS CO., LTD., Suwon-si (KR)

(21) Appl. No.: 19/437,825

(22) Filed: Dec. 31, 2025

(30) Foreign Application Priority Data
Jan. 24, 2025 (KR) 10-2025-0011894

(51) Int. Cl. H04W 24/10; H04B 17/309; H04B 17/318

(52) U.S. Cl. CPC H04W 24/10; H04B 17/328; H04B 17/346

(57) ABSTRACT

A communication module includes a radio resource management (RRM) measurer configured to measure a first RRM value of a first period, and to generate a plurality of RRM measurement values including the first RRM value of the first period, an RRM predictor configured to predict a second RRM value of a second period, based on the plurality of RRM measurement values, and to generate a plurality of RRM prediction values including the second RRM value of the second period, one or more communication processors including processing circuitry, and memory storing instructions. The instructions, when executed by the one or more communication processors individually or collectively, cause the communication module to select at least one target RRM measurement value from among the plurality of RRM measurement values, and update the RRM predictor based on the at least one target RRM measurement value.

### CROSS-REFERENCE TO RELATED APPLICATION

This application is based on and claims priority under 35 U.S.C. § 119 to Korean Patent Application No. 10-2025-0011894, filed on Jan. 24, 2025, in the Korean Intellectual Property Office, the disclosure of which is incorporated by reference herein in its entirety.

### BACKGROUND

The present disclosure relates to a communication module for predicting radio resource management (RRM) based on on-device learning, a method of operating the same, and an electronic device.

Fifth generation (5G) wireless communication technologies may define a wide frequency band that may provide relatively fast transmission speeds and/or new services. For example, the wide frequency band may be implemented as a sub-6 gigahertz (6 GHz) frequency band and/or as a 3.5 GHz frequency band. As another example, the wide frequency band may be implemented as an ultra-high frequency band (e.g., above 6 GHz), which may be referred to as a millimeter wave (mmWave), such as, but not limited to, 28 GHz or 39 GHz. In addition, sixth generation (6G) wireless communication technologies, which may refer to wireless communication systems after 5G wireless communication systems (Beyond 5G), may implement the wide frequency band in the terahertz (THz) band (e.g., between 3 THz and 95 GHz) may be considered to potentially provide transmission speeds that may be considerably faster (e.g., 50 times) than 5G wireless communication technologies and/or may potentially provide ultra-low delay times that may be significantly reduced (e.g., by one-tenth) from 5G wireless communication technologies.

Several techniques and/or technologies may have been implement and/or deployed along with the 5G wireless communication technologies in an attempt to support services and/or satisfy performance requirements for features of the 5G wireless communication systems that may include, but not be limited to, enhanced mobile broadband (eMBB), ultra-reliable low-latency communications (URLLC), and massive machine-type communications (mMTC). For example, such techniques may include carrying out standardization on beamforming and/or massive multiple input multiple output (MIMO) to potentially reduce path loss of radio waves in ultra-high frequency bands and/or potentially increase the transmission distance of radio waves. As another example, various numerology support (such as, but not limited to, operation of multiple subcarrier intervals) may have been implemented in an attempt to improve the efficient use of ultra-high frequency resources. Other techniques may include, but not be limited to, dynamic operation of slot formats, initial access technology to support multi-beam transmission and wideband, definition and operation of bandwidth part (BWP), new channel coding methods such as, but not limited to, low density parity check (LDPD) codes for large-capacity data transmission and polar codes for reliable transmission of control information, Level 2(L2 ) pre-processing, network slicing that may provide dedicated networks specialized for specific services, or the like.

Recently, additional possible techniques for improving the initial 5G wireless communication technologies and/or enhancing the performance of such technologies may be being discussed, which may take into account the services that the 5G wireless communication technologies were initially intended to support. For example, these additional techniques may include, but not be limited to, physical layer standardization may be in progress for technologies such as, but not limited to, vehicle-to-everything (V2X) to potentially assist in driving decisions of autonomous vehicles and/or increase user convenience based on location and status information transmitted by vehicles, new radio (NR) unlicensed (NR-U) band that may permit system operation that may comply with various regulatory requirements in unlicensed bands, NR terminal low power consumption technology (e.g., UE power saving), non-terrestrial network (NTN), which may provide direct terminal-satellite communication that may provide coverage in areas where communication with terrestrial networks may not be possible, and/or positioning.

Commercial implementation and/or deployment of such 5G wireless communication systems may result in an explosive increase of connected devices that may be connected to the communication network. Accordingly, the functions and/or performance of 5G wireless communication systems may need to be strengthened and/or integrated operation of connected devices may be needed. To this end, new research may be being conducted to potentially improve 5G performance and/or reduce complexity using techniques such as, but not limited to, extended reality (XR), artificial intelligence (AI), and/or machine learning (ML) that may support augmented reality (AR), virtual reality (VR), and/or mixed reality (MR), which may be used provide AI and/or ML services, metaverse services, and/or drone communications. Possible advancements of these 5G wireless communication systems may serve as the basis for the development of AI-based communication technologies that may utilize AI from the design stage and embed end-to-end AI functions to potentially achieve system optimization.

For example, as part of a continuous mobile broadband evolution promulgated by the Third Generation Partnership Project (3GPP) (e.g., 3GPP Release 18) various study items may have been conducted to potentially introduce and/or apply AI and/or ML-based communication technologies to 5G NR wireless communication systems. For example, AI and/or ML-based communication technologies may be applied to various aspects of the wireless communication systems, such as, but not limited to, channel state information (CSI) measurement and/or reporting, beam management, and/or positioning.

In addition, the AI and/or ML models may be applied to technologies that may predict radio resource management (RRM). However, use of AI and/or ML models for RRM prediction technology (on-device learning) may be constrained by significant errors that may occur in the RRM predictions due to an inability to reflect changes in the wireless communication environment after initial learning, such as, but not limited to, changes in antennas or radio frequency (RF) circuits in electronic devices (e.g., terminals), changes in the internal temperature of electronic devices, or the like.

### SUMMARY

Example embodiments of the present disclosure provide a communication module capable of adaptively predicting radio resource management (RRM) by reflecting changes in internal/external environments of an electronic device and/or changes in a configuration of an electronic device, a method of operating the same, and an electronic device.

The technical aspects of the present disclosure are not limited to the technical aspects mentioned above, and other technical aspects not mentioned may be apparent to those skilled in the art from the description below.

According to an aspect of the present disclosure, a communication module includes a radio resource management (RRM) measurer configured to measure a first RRM value of a first period, and to generate a plurality of RRM measurement values including the first RRM value of the first period, an RRM predictor configured to predict a second RRM value of a second period, based on the plurality of RRM measurement values, and to generate a plurality of RRM prediction values including the second RRM value of the second period, one or more communication processors including processing circuitry, and memory storing instructions. The instructions, when executed by the one or more communication processors individually or collectively, cause the communication module to select at least one target RRM measurement value from among the plurality of RRM measurement values, and update the RRM predictor based on the at least one target RRM measurement value.

According to an aspect of the present disclosure, a method of operating a communication module includes generating a plurality of RRM measurement values by measuring RRM values of first periods, generating a plurality of RRM prediction values by predicting RRM values of second periods corresponding to the plurality of RRM measurement values, selecting at least one target RRM measurement value from among the plurality of RRM measurement values, and updating an RRM predictor based on the at least one target RRM measurement value.

According to an aspect of the present disclosure, an electronic device includes a communication module including an RRM measurer, memory storing instructions, and one or more processors including an RRM predictor. The instructions, when executed by the one or more processors individually or collectively, cause the electronic device to measure, using the RRM measurer, a first RRM measurement value, generate a plurality of RRM measurement values including the first RRM measurement value, predict, using the RRM predictor, a plurality of RRM prediction values based on the plurality of RRM measurement values, select at least one target RRM measurement value from among the plurality of RRM measurement values, based on a loss function for the plurality of RRM measurement values and the plurality of RRM prediction values, store the at least one target RRM measurement value in the memory, and update the RRM predictor based on the at least one target RRM measurement value stored in the memory.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 illustrates a wireless communication system, according to an embodiment;

FIG. 2 illustrates a configuration of an electronic device of FIG. 1, according to an embodiment;

FIG. 3 illustrates a configuration of a communication module, according to an embodiment;

FIG. 4 is a diagram illustrating an example of an operation of a communication module, according to an embodiment;

FIG. 5 is a flowchart illustrating a method of operating a communication module, according to an embodiment;

FIG. 6 is a flowchart illustrating a method of operating a communication module, according to an embodiment;

FIG. 7 is a flowchart illustrating a method of operating a communication module, according to an embodiment;

FIG. 8 is a block diagram illustrating an electronic device, according to an embodiment;

FIG. 9 is a block diagram illustrating an electronic device, according to an embodiment; and

FIG. 10 is a diagram illustrating an example of electronic devices to which an embodiment is applied.

### DETAILED DESCRIPTION

Hereinafter, embodiments of the present disclosure are described with reference to the accompanying drawings. Although embodiments of the present disclosure are illustrated in the drawings and described in connection therewith, they are not intended to limit various embodiments of the present disclosure to a specific form. For example, it may be apparent to those skilled in the art that embodiments of the present disclosure may be variously modified.

In describing an embodiment in the present disclosure, description of technical contents that may be well known in the technical field to which the present disclosure belongs and may not be directly related to the present disclosure may be omitted, in order to convey the gist of the present disclosure more clearly without obscuring the gist by omitting unnecessary explanations. In addition, detailed descriptions of known functions and configurations that may obscure the gist of the present disclosure may be omitted.

Advantages and features of the present disclosure and methods of achieving them may become apparent with reference to the embodiments described below in conjunction with the accompanying drawings. However, the present disclosure may not be limited to the embodiments disclosed below and may be implemented in various different forms, and the current embodiments may be provided only to make the disclosure of the present disclosure complete and to fully inform those skilled in the art to which the present disclosure belongs of the scope of the disclosure, and the present disclosure may be defined only by the scope of the claims. Throughout the disclosure, the same reference numerals may refer to the same components.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that each block of the processing flow diagrams and combinations of the flow diagrams may be performed by computer program instructions. Because these computer program instructions may be embedded in a processor of a general-purpose computer, a special-purpose computer, or other programmable data processing apparatus, the instructions executed by the processor of the computer or other programmable data processing apparatus may create a means for performing the functions described in the flowchart blocks. Because these computer program instructions may also be stored in a computer-available or computer-readable memory that may direct a computer or other programmable data processing apparatus in order to implement a function in a specific manner, the instructions stored in the computer-available or computer-readable memory may also produce an article of manufacture that may include instruction means for performing the function described in the flowchart blocks. Because the computer program instructions may be mounted on a computer or other programmable data processing apparatus, a series of operational steps may be performed on the computer or other programmable data processing apparatus to produce a computer-executable process, so that the instructions executing the computer or other programmable data processing apparatus may also provide steps for executing the functions described in the flowchart blocks.

In addition, each block may represent a module, segment, or part of code including one or more executable instructions for executing specific logical functions. Also, it may be noted that in some alternative execution examples the functions mentioned in the blocks may occur out of order. For example, two blocks shown in succession may be executed substantially simultaneously (e.g., at substantially the same time), and/or the blocks may be executed in reverse order, according to their respective functions.

Components described with reference to terms such as unit, module, block, ~or, ~er, or device used in the detailed description and functional blocks depicted in the drawings may be implemented in the form of software, hardware, or a combination thereof. For example, the software may be machine code, firmware, embedded code, and application software. For example, the hardware may include electrical circuits, electronic circuits, processors, computers, integrated circuits, integrated circuit cores, pressure sensors, inertial sensors, microelectromechanical systems (MEMS), passive elements, or a combination thereof.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The embodiments of the present disclosure are described in relation to a new radio (NR) access network (RAN) and/or a packet core network (e.g., a fifth generation (5G) system, a 5G, core network, or a next generation (NG) core network) of a 5G mobile communication standard promulgated by the Third Generation Partnership Project (3GPP), a mobile communication standard standardization organization. However, the embodiments of the present disclosure are not limited thereto. Notably, the present disclosure may be applied to other communication systems having a similar technical background with slight modifications without significantly departing from the scope of the present disclosure, which may be possible at the discretion of those skilled in the art of the present disclosure.

For convenience of explanation below, some terms and names defined in the 3GPP long term evolution (LTE) standards (e.g., standards for 5G, NR, LTE, or similar systems) may be used. However, the terms and names of the present disclosure may not be limited and may be equally applied to systems complying with other standards.

Terms referring to signals, terms referring to channels, terms referring to control information, and terms referring to components of devices used in the following description may be exemplified for convenience of description. Therefore, the terms used in the present disclosure may not be limited and other terms that may refer to objects having equivalent technical meanings may be used.

In the present disclosure, an RRM prediction module may include at least one artificial intelligence (AI) model, and updating the RRM prediction module may refer to retraining the RRM prediction module (e.g., the at least one AI model included in the RRM prediction module) based on a collected data set (e.g., at least one target RRM measurement value stored in memory).

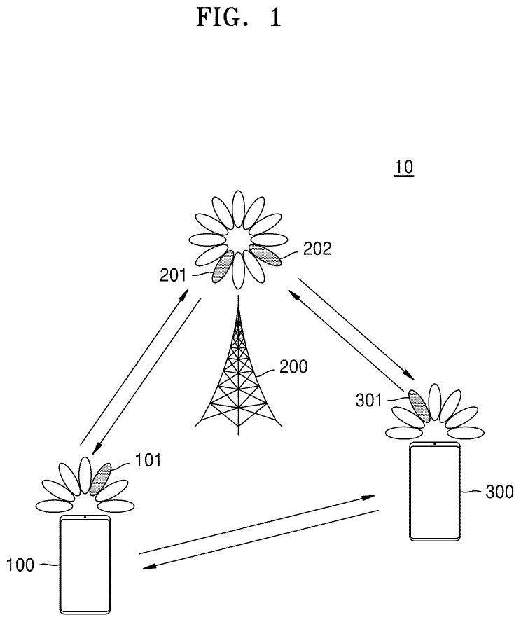

FIG. 1 illustrates a wireless communication system, according to an embodiment.

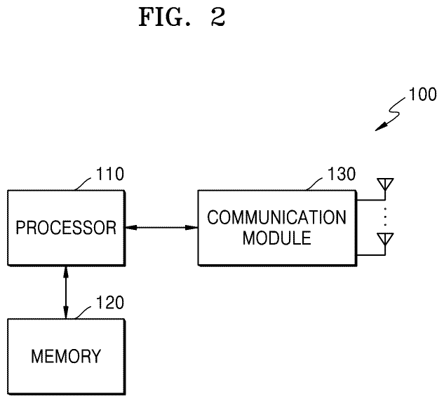

Referring to FIG. 1, a wireless communication system 10 may include a first electronic device 100, a base station 200, and a second electronic device 300 using a wireless channel in the wireless communication system 10. Although FIG. 1 illustrates the wireless communication system 10 as including only one base station, another base station substantially similar to and/or the same as the base station 200 may be further included. The first electronic device 100 of FIG. 1 may correspond to the electronic devices described with reference to FIGS. 2 to 10.

The base station 200 may be and/or may a network infrastructure element of the wireless communication system 10 that may provide wireless access to the first and second electronic devices 100 and 300. The base station 200 may provide a coverage for a certain geographical area that may be based on a distance at which a signal from the base station 200 may be transmitted. The base station 200 may be referred to as an access point (AP), an evolved universal mobile telecommunications system (UMTS) terrestrial radio access network (E-UTRAN) node B (eNodeB or eNB), a 5th generation node, a next generation node B (gNB), a wireless point, a transmission/reception point (TRP), and/or other terms having equivalent technical meanings in addition to the base station.

Each of the first electronic device 100 and the second electronic device 300 may be and/or may include a device used by a user that may communicate with the base station 200 through the wireless channel. A link from the base station 200 to the first electronic device 100 and/or the electronic device 300 may be referred to as a downlink (DL), and a link from the first electronic device 100 and/or the second electronic device 300 to the base station 200 may be referred to as an uplink (UL). In addition, the first electronic device 100 and/or the second electronic device 300 may communicate with each other through the wireless channel. As used herein, a link between the first electronic device 100 and the second electronic device 300 may be referred to as a sidelink and/or as a PC5 interface. In some cases, at least one of the first electronic device 100 or the second electronic device 300 may be operated without user intervention. That is, at least one of the first electronic device 100 or the second electronic device 300 may be and/or may include a device performing machine type communication (MTC) that may not be carried (or operated) by the user. Each of the first electronic device 100 and the second electronic device 300 may be referred to as a terminal, and/or other terms having equivalent technical meanings, such as, but not limited to, user equipment (UE), mobile station, subscriber station, remote terminal, wireless terminal, or user device.

The base station 200, the first electronic device 100, and the second electronic device 300 may transmit and/or receive wireless signals in a millimeter wave (mmWave) band (e.g., 28 GHz, 30 GHz, 38 GHz, or 60 GHz). In an embodiment, the base station 200, the first electronic device 100, and/or the second electronic device 300 may perform beamforming to attempt to improve channel gain. As used herein, beamforming may refer to transmitting beam-formed signals and/or receiving beam-formed signals. That is, the base station 200, the first electronic device 100, and/or the second electronic device 300 may provide directivity to a transmitted signal and/or a received signal. To this end, the base station 200 and/or the first and second electronic devices 100 and 300 may select serving beams (e.g., a first serving beam 101, a second serving beam 201, a third serving beam 202, and a fourth serving beam 301) through a beam search and/or beam management procedure. After the first to fourth serving beams 101 to 301 have been selected, subsequent communication may be performed through resources that may be in a quasi co-located (QCL) relationship with the resources transmitting the first to fourth serving beams 101 to 301.

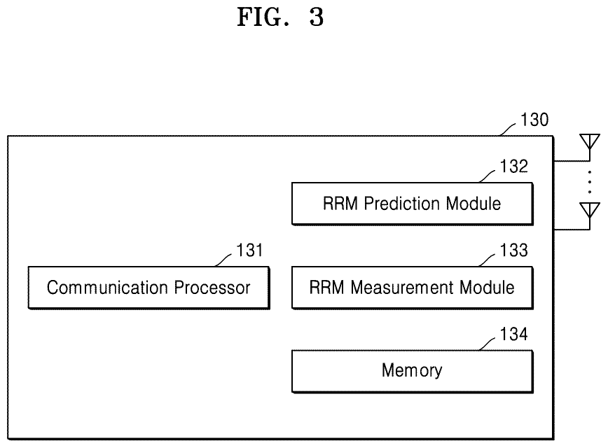

When large-scale characteristics of a channel carrying a symbol on a first antenna port are inferred from a channel carrying a symbol on a second antenna port, the first antenna port and the second antenna port may be evaluated to be in the QCL relationship. For example, the large-scale characteristics may include at least one of a delay spread, a Doppler spread, a Doppler shift, an average gain, an average delay, or a spatial receiver parameter. A communication module, according to an embodiment, may select at least one target radio resource management (RRM) measurement by using some (e.g., the Doppler spread and/or the Doppler shift) of the large-scale characteristics described above, as described with reference to FIGS. 3 to 7.

The electronic device 100 and the electronic device 300 illustrated in FIG. 1 may support vehicle communication. For vehicle communication, standardization work for vehicle-to-everything (V2X) technology based on a device-to-device (D2D) communication structure in a LTE system may have been promulgated by the 3GPP (e.g., 3GPP Release 14 and Release 15), and/or efforts may be underway to develop V2X technology based on 5G NR.

In an embodiment, the base station 200 may be and/or may include an entity performing resource allocation of electronic devices that may support both V2X communication and general cellular communication, and/or may only support V2X communication. That is, the base station 200 may be referred to as an NR base station (e.g., gNB), an LTE base station (e.g., eNB), or a road side unit (RSU).

In an embodiment, the base station 200 and/or the first and second electronic devices 100 and 300 may be connected through a Uu interface. As used herein, uplink (UL) may refer to a wireless link through which an electronic device (e.g., the first electronic device 100 or the second electronic device 300) transmits data and/or a control signal to a base station (e.g., the base station 200), and downlink (DL) may refer to a wireless link through which a base station (e.g., the base station 200) transmits data and/or a control signal to an electronic device (e.g., the first electronic device 100 or the second electronic device 300).

As 5G wireless communication systems (e.g., the wireless communication system 10) may become commercialized, various types of devices may be connected to the communication network, and accordingly, functions and/or performance of the 5G wireless communication system may need to be strengthened and/or integrated with the operation of the connected devices. To this end, various study items may have been conducted to introduce and/or apply AI and/or machine learning (ML)-based communication technologies to 5G NR wireless communication systems. For example, 3GPP Release 18 may apply AI-based communication technology to several representative cases (e.g., channel state information (CSI) reporting, beam management, and positioning).

Recently, interest within the 3GPP in predicting RRM using an AI model may have increased. As used herein, an AI model may include a software configuration for learning (or training) a specific pattern of learning data and generating a specific prediction value (or a specific inference value) based on the learned pattern, and a hardware configuration for implementing the software configuration. In addition, RRM may include at least one of a reference signal received power (RSRP), a reference signal received quality (RSRQ), a received signal strength indicator (RSSI), or a signal-to-interference-plus-noise ratio (SINR) that may be measured in the wireless communication system 10. However, when predicting RRM based on the AI model, prediction errors may occur due to changes in the external environment of the electronic device (e.g., changes in a wireless communication environment), changes in the configuration of the electronic device (e.g., an antenna or a radio frequency (RF) circuit), and/or changes in the internal environment of the electronic device (e.g., a temperature). Consequently, accuracy of an RRM prediction value may be significantly reduced. Thus, it may be necessary to update an RRM prediction module (e.g., the AI model for RRM prediction) according to changes in internal/external environments of the electronic device (e.g., the first electronic device 100 or the second electronic device 300) and/or changes in the configuration of the electronic device or the wireless communication system (e.g., the wireless communication system 10).

Therefore, the communication module, according to an embodiment, may need to adaptively update the RRM prediction module (e.g., an AI model for RRM prediction) by reflecting changes in the internal/external environments of the electronic device and/or changes in the configuration to provide a communication module that may be resistant to changes in the internal/external environments of the electronic device and the electronic device 100 including the same, as described with reference to FIGS. 2 to 10.

FIG. 2 illustrates a configuration of the first electronic device 100 of FIG. 1, according to an embodiment. It is to be understood that the descriptions of the first electronic device 100 with reference to FIG. 2 may be similarly applicable to the second electronic device 300 illustrated in FIG. 1.

Referring to FIG. 2, the first electronic device 100 may include a processor 110, memory 120, and a communication module 130. The processor 110, the memory 120, and the communication module 130 may be implemented as hardware, software, or a combination of hardware and software.

The communication module 130 may perform functions for transmitting and/or receiving signals through a wireless channel. For example, the communication module 130 may perform a conversion function between a baseband signal and a bit stream according to a physical layer specification of a system (e.g., the wireless communication system 10). For example, when transmitting data, the communication module 130 may generate complex symbols by encoding and/or modulating a transmission bit stream. Alternatively or additionally, when receiving data, the communication module 130 may restore a received bit stream by demodulating and/or decoding the baseband signal. In addition, the communication module 130 may up-convert the baseband signal into an RF band signal and may transmit the RF band signal through an antenna, and may down-convert the RF band signal received through the antenna into a baseband signal. For example, the communication module 130 may include a transmitting filter, a receiving filter, an amplifier, a mixer, an oscillator, a digital-to-analog converter (DAC), an analog-to-digital converter (ADC), or the like.

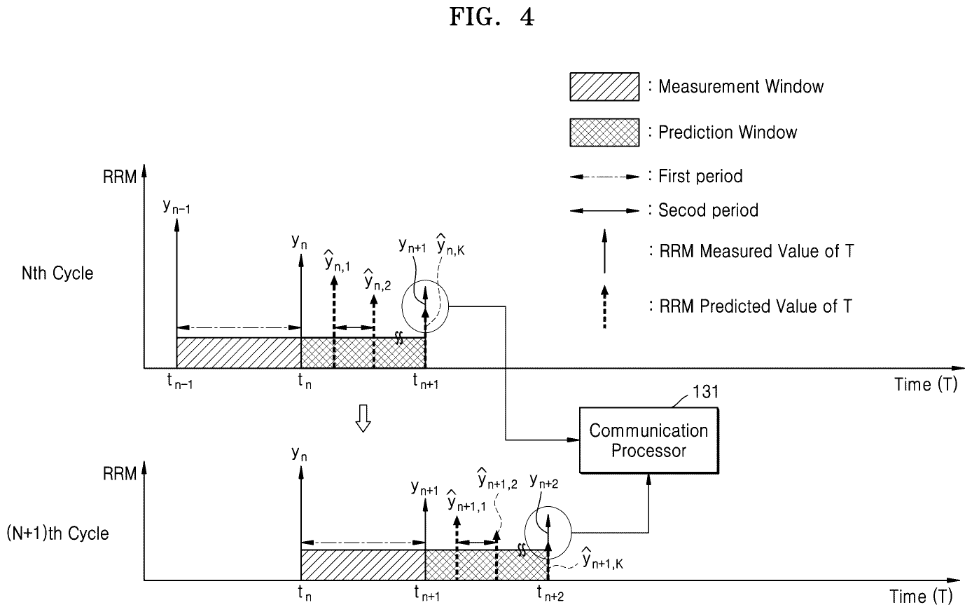

In addition, the communication module 130 may include a plurality of transmission and/or reception paths. Furthermore, the communication module 130 may include at least one antenna array including a plurality of antenna elements. For example, the communication module 130 may include a digital circuit and/or an analog circuit (e.g., a radio frequency integrated circuit (RFIC)). In an embodiment, the digital circuit and the analog circuit may be implemented as one package. In addition, the communication module 130 may include a plurality of RF chains. Furthermore, the communication module 130 may perform beamforming. The configuration included in the communication module 130, according to an embodiment, is described with reference to FIG. 4.

The communication module 130 may transmit and/or receive signals as described above. Accordingly, all or part of the communication module 130 may be referred to as a transmitter, a receiver, and/or a transceiver. As used herein, transmission and/or reception performed through the wireless channel may refer to transmission and/or reception as described above that may be performed by the communication module 130.

The communication module 130, according to an embodiment, may adaptively update the RRM prediction module (e.g., the AI model for RRM prediction) by reflecting a change in the internal/external environments of the electronic device 100 and/or a change in configuration. The RRM may include at least one of an RSRP, an RSRQ, an RSSI, or an SINR that may be measured in the wireless communication system 10. In an embodiment, the communication module 130 may calculate a difference value (e.g., a loss function) between an RRM measurement value and an RRM prediction value corresponding to the RRM measurement value. When the difference value satisfies a predetermined condition (e.g., a first threshold>a difference value>a second threshold), the communication module 130 may select an RRM measurement value (e.g., at least one target RRM measurement value) satisfying the condition from among a plurality of RRM measurement values and may store the RRM measurement value in the memory 120. When calculating the difference value, the communication module 130 may additionally use data measured by at least one of the transmitter, the receiver, or a sensor of the electronic device 100.

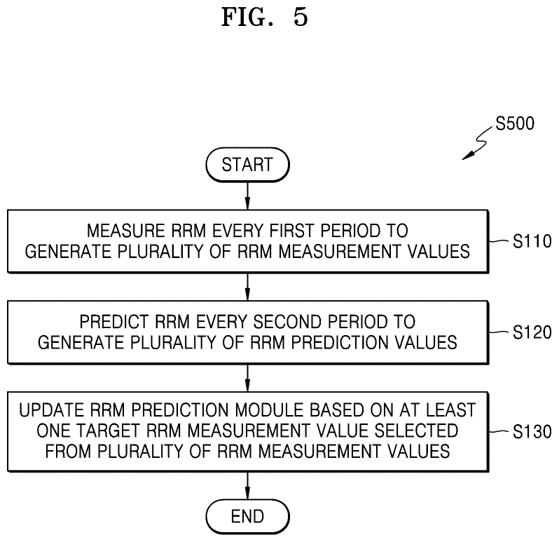

When the data size of the RRM measurement value (e.g., at least one target RRM measurement value) stored in the memory 120 is greater than or equal to a threshold (e.g., a third threshold), the communication module 130 may update the RRM prediction module (e.g., the AI model for RRM prediction) based on the RRM measurement value stored in the memory 120, as described with reference to FIGS. 5 to 7.

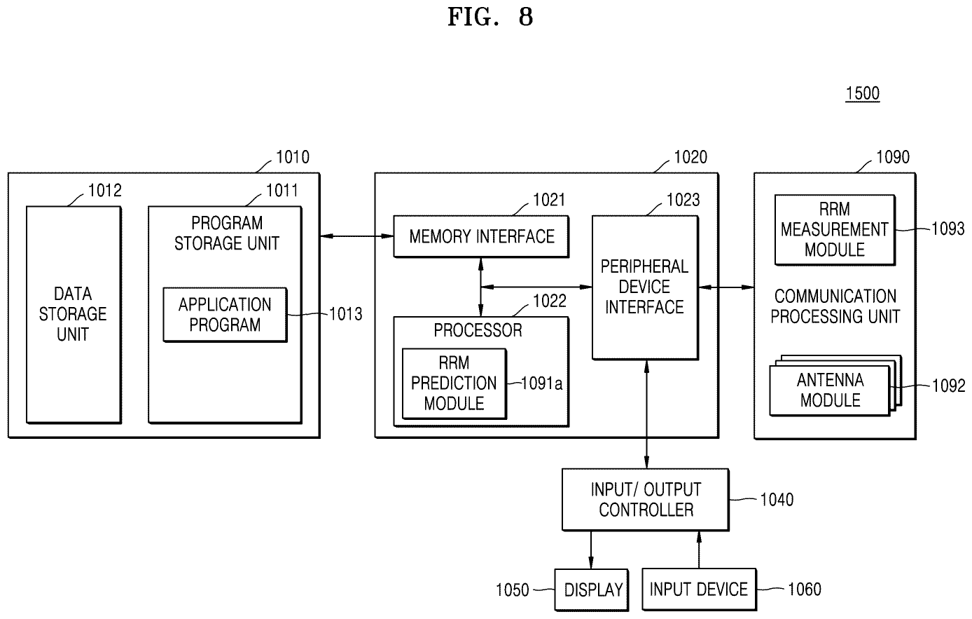

The communication module 130, according to an embodiment, may delete an RRM measurement value having a storage period that is greater than or equal to a threshold (e.g., a fourth threshold) from among RRM measurements (e.g., at least one target RRM measurement value) stored in the memory 120, as described with reference to FIG. 8.

The memory 120 may store data such as, but not limited to, a basic program, an application program, and setting information for the operation of the electronic device 100. The memory 120 may include volatile memory, non-volatile memory, or a combination of volatile memory and non-volatile memory. In addition, the memory 120 may provide stored data according to the request of the processor 110.

The processor 110 may control the overall operation of the electronic device 100. For example, the processor 110 may transmit and/or receive signals through the communication module 130. In addition, the processor 110 may write and/or read data to and/or from the memory 120. In addition, the processor 110 may perform functions of a protocol stack required by a communication standard. To this end, the processor 110 may include at least one processor or micro-processor, and/or may be part of the processor. In addition, part of the communication module 130 may be referred to as a communication processor. According to embodiments, the communication processor may control the communication module 130 to perform operations (e.g., operations of FIGS. 5 to 7) as described below. The communication processor may be included in the communication module 130. However, embodiments of the present disclosure are not limited thereto, and the communication processor, according to an embodiment, may be included outside the communication module 130 (e.g., the processor 110). In an embodiment, the communication module 130 may include one or more communication processors comprising processing circuitry that may execute, individually or collectively, instructions stored in a memory to perform one or more embodiments of the present disclosure.

FIG. 3 illustrates a configuration of a communication module 130, according to an embodiment.

Referring to FIG. 3, the communication module 130 may include a communication processor 131, an RRM prediction module (or RRM predictor) 132, an RRM measurement module (or RRM measurer) 133, and memory 134. In an embodiment, the communication processor 131, the RRM prediction module 132, the RRM measurement module 133, and the memory 134 may be implemented as hardware, software, or a combination of hardware and software.

In an embodiment, the RRM prediction module 132 and/or the RRM measurement module 133 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the RRM prediction module 132 and/or the RRM measurement module 133. As another example, a processor in combination with a memory may be used to execute one or more instructions to perform the functionality of each of the RRM prediction module 132 and the RRM measurement module 133. Alternatively or additionally, at least a portion of the functionality of the RRM prediction module 132 and/or the RRM measurement module 133 may be incorporated into the communication processor 131 and/or implemented as instructions to be executed by the communication processor 131.

Although FIG. 3 illustrates the communication processor 131 as a single processor, the present disclosure is not limited thereto. For example, the communication processor 131 may include one or more communication processors comprising processing circuitry that may execute, individually or collectively, instructions stored in a memory (e.g., the memory 134 or the memory 120) to perform one or more embodiments of the present disclosure.

The communication processor 131 may control the overall operation of the communication module 130. In an embodiment, the communication processor 131 may control the RRM measurement module 133 to generate the plurality of RRM measurement values for each first period, and/or may control the RRM prediction module 132 to generate a plurality of RRM prediction values based on the plurality of RRM measurement values for each second period. In an embodiment, the first period may be longer than the second period. That is, an RRM measurement cycle may be longer than an RRM prediction cycle. For example, the number of RRM measurements measured over a period T may be less than the number of RRM predictions predicted over the same period T.

In an embodiment, the communication processor 131 may select at least one target RRM measurement value satisfying a predetermined condition from among the plurality of RRM measurements. For example, the communication processor 131 may calculate the difference value by using a loss function comparing some of the plurality of RRM measurement values with some RRM prediction values. In an embodiment, some RRM prediction values may be RRM prediction values corresponding to some of the plurality of RRM prediction values. The loss function may be based on at least one of a mean squared error (MSE), a root mean squared error (RMSE), a mean absolute error (MAE), or a Gaussian negative log-likelihood loss.

For example, the communication processor 131 may determine whether the difference value is less than the first threshold and greater than the second threshold (e.g., first threshold>difference value>second threshold). The communication processor 131 may select an RRM measurement value in which the difference value is less than the first threshold (e.g., an upper threshold of the loss function) and greater than the second threshold (e.g., a lower threshold of the loss function) from the some of the plurality of RRM measurement values as at least one target RRM measurement value. In an embodiment, the first and second thresholds may be determined in advance as hyper-parameters. However, embodiments of the present disclosure are not limited thereto. For example, the first and second thresholds may be adaptively changed according to the wireless communication environment 10.

The communication processor 131 may determine an RRM measurement value in which the difference value is greater than the first threshold as an outlier and may delete the RRM measurement value, in order to prevent updating the RRM prediction module 132 based on the outlier in advance. In an embodiment, when the first threshold is set to infinite (inf or ‘∞’), according to the wireless communication environment 10, the RRM prediction module 132 may be updated based on data including the outlier. When the difference value is less than the second threshold, the communication processor 131 may determine that the RRM prediction module 132 (e.g., the AI model included in the RRM prediction module 132) operates stably and may predict the RRM with a relatively high accuracy. The communication processor 131 may control an update frequency of the RRM prediction module 132 by changing the second threshold to prevent power waste due to frequent updates of the RRM prediction module 132. For example, the communication processor 131 may set the second threshold to zero (0) to update the RRM prediction module 132 based on the RRM measurement value with a small difference value (e.g., an RRM measurement value with a small loss). The communication processor 131 may store at least one selected target RRM measurement value in the memory 134.

In an embodiment, the communication processor 131 may further include an additional AI model, and the communication processor 131 may select at least one target RRM measurement value from the plurality of RRM measurement values by using the additional AI model (e.g., a deep neural network (DNN)), in addition to selecting at least one target RRM measurement value by quantitatively calculating a difference value based on the first and second thresholds described above. In an embodiment, the additional AI model may receive the plurality of RRM prediction values and the plurality of RRM measurement values, and may output a binary value as a decision on whether a specific RRM measurement value is a target RRM measurement value. That is, the additional AI model may determine whether a specific RRM measurement value is an RRM measurement value to be stored in the memory 134 and used for updating the RRM prediction module 132. For example, when the specific RRM measurement value is selected as at least one target RRM measurement value, the additional AI model may output one (1), and when the specific RRM measurement value is not selected as at least one target RRM measurement value, the additional AI model may output zero (0)′. However, embodiments of the present disclosure are not limited thereto. For example, the additional AI model may output various other values that may signify whether the specific RRM measurement value is selected as a target RRM measurement value. The communication processor 131 may store only the specific RRM measurement value for which the output value of the additional AI model is one (1) in the memory 134.

In an embodiment, when calculating the difference value, the communication module 130 may additionally use at least one of a measurement value related to Doppler spread and shift measured by the receiver of the communication module 130, a measurement value related to timing advance and transmission power control (e.g., a transmission power control command) measured by the transmitter of the communication module 130, or a sensing value of a gyroscopic sensor electrically connected to the communication module 130.

In an embodiment, the communication processor 131 may control the memory 134 to delete a target RRM measurement value of which the storage period is greater than or equal to a fourth threshold from among at least one target RRM measurement value stored in the memory 134. The fourth threshold may be determined in advance as a hyper-parameter. However, embodiments of the present disclosure are not limited thereto. For example, the fourth threshold may be adaptively changed according to the wireless communication environment 10. In addition, the fourth threshold may be a value set in a flushing timer of the communication processor 131. For example, when the fourth threshold is set to infinite, the communication processor 131 may update the RRM prediction module 132 based on all target RRM measurement values stored in the memory 134. That is, when the fourth threshold is set to infinite, the communication processor 131 may not delete target RRM measurement values from the memory 134. As another example, the communication processor 131 may update weights and/or parameters of the AI model (e.g., the AI model designed to predict RRM according to a learned pattern) included in the RRM prediction module 132. The storage period may refer to the total period in which the target RRM measurement value is stored in the memory 134. Because each of at least one target RRM measurement value simulates the wireless communication environment or channel environment at the time each of at least one target RRM measurement value is stored in the memory 134, the longer the storage period, the less likely it is that the target RRM measurement value may accurately simulate the current wireless communication environment or channel environment. That is, the longer the storage period of the target RRM measurement value, the less reliable the target RRM measurement value may be. Therefore, the communication processor 131, according to an embodiment, may obtain an RRM prediction value with relatively high accuracy while maximizing the efficiency of RRM prediction by updating the RRM prediction module 132 based on a target RRM measurement value (e.g., relatively high reliability data) temporally close to the current wireless communication environment or channel environment.

In an embodiment, the communication processor 131 may prematurely terminate an operation for updating the RRM prediction module 132 (e.g., the AI model included in the RRM prediction module 132) when RRM measurement is not possible for a certain period of time. When RRM measurement becomes possible in the future, the update operation for the RRM prediction module 132 (e.g., the AI model included in the RRM prediction module 132) may be restarted by a request/triggering of the base station or communication processor 131.

The RRM measurement module 133 may measure RRM by control of the communication processor 131 to generate the plurality of RRM measurement values. The RRM measurement module 133 may generate the plurality of RRM measurement values for each first period in each cycle. The RRM measurement module 133 may generate an RRM measurement value by using various types of wireless communication resources (e.g., a synchronization signal block (SSB) and a channel state information-reference signal (CSI-RS)) transmitted from the base station 200. In an embodiment, the first period for RRM measurement (e.g., the RRM measurement cycle) may be longer than the second period for RRM prediction (e.g., the RRM prediction cycle).

The RRM prediction module 132 may predict RRM by control of the communication processor 131 to generate the plurality of RRM prediction values. The RRM prediction module 132 may generate the plurality of RRM prediction values for each second period in each cycle. For example, the RRM prediction module 132 may predict the RRM of a next period based on the plurality of RRM measurement values measured in a previous period to generate the plurality of RRM prediction values for each second period. The RRM may include at least one of an RSRP, an RSRQ, an RSSI, or an SINR. However, embodiments of the present disclosure are not limited thereto, and the RRM, according to an embodiment, may include various RRM measurement values (or RRM measurement metrics) that may be obtained in the wireless communication system 10. Because the RRM prediction module 132, according to an embodiment, may be adaptively updated, according to a change in the wireless communication environment to generate an RRM prediction value with high accuracy, the measurement cycle (e.g., the first period) of the RRM measurement module 133 may be longer than the prediction cycle (e.g., the second period) of the RRM prediction module 132. The communication module 130, according to an embodiment, may reduce power consumption for RRM measurement and may prevent system overload caused by excessive RRM measurement as the measurement cycle (e.g., the first period) of the RRM measurement module 133 becomes longer.

The memory 134 of the communication module 130 may store at least one AI model for predicting RRM. The at least one AI model may include an artificial neural network (e.g., a deep learning neural network) for learning (or training) a specific pattern of training data and generating an RRM prediction value (or an RRM inference value) based on the learned pattern. The memory 134 may store the first and second thresholds for selecting at least one target RRM measurement value, the third threshold for determining whether to update the RRM prediction module 132 (e.g., the batch size for updating the RRM prediction module 132), and the fourth threshold for deleting a low-reliability target RRM measurement value (e.g., a target RRM measurement value with a long storage period). In addition, the memory 134 may store at least one target RRM measurement value selected from the plurality of RRM measurement values. Although the memory 134 is illustrated in FIG. 3 as being included in the communication module 130, the present disclosure is not limited thereto, and the memory 134 may be included outside the communication module 130 (e.g., the memory 120 of FIG. 2).

Although a predetermined condition (e.g., a range of a difference value) for selecting at least one target RRM measurement value is described as being less than the first threshold and greater than the second threshold, the present disclosure is not limited thereto. The predetermined condition, according to an embodiment, may be adaptively changed to various conditions according to a wireless communication environment. For example, the predetermined condition may be based on only one of the first threshold (e.g., the upper threshold of the loss function) and the second threshold (e.g., the lower threshold of the loss function).

In the communication module 130, the method of operating the same, and the electronic device, according to various embodiments, the RRM prediction module 132 may be adaptively updated by reflecting changes in internal and/or external environments of the electronic device (e.g., the first electronic device 100 or the second electronic device 300) or changes in the configuration of the electronic device to improve the accuracy of RRM prediction and to prevent occurrence of radio link failure (RLF) and/or handover failure (HOF).

Furthermore, in the communication module 130, the method of operating the same, and the electronic device, according to various embodiments, the RRM measurement cycle may be increased based on a high-accuracy RRM prediction value to reduce the usage of wireless resources for RRM measurement, to prevent the occurrence of system overhead due to excessive RRM measurement, and to maximize the overall communication performance of the electronic device.

FIG. 4 is a diagram illustrating an example of an operation of a communication module 130, according to an embodiment.

Referring to FIG. 4, a framework for RRM prediction of the communication module 130 is illustrated, according to an embodiment. As shown in FIG. 4, in an Nth cycle, tₙ may represent a reference time point, a measurement window may include a time period from time point tₙ₋₁ to time point tₙ, and a prediction window may include a time period from time point tₙ to time point tₙ₊₁. In an (N+1)th cycle, tₙ₊₁ may represent a reference time point, a measurement window may include a time period from time point tₙ to time point tₙ₊₁, and a prediction window may include a time period from time point tₙ₊₁ to time point tₙ₊₂. As used herein, the reference time point may be a reference time point used for dividing the measurement window and the prediction window. For example, in the Nth cycle, the communication processor 131 may control the RRM measurement module 133 during the measurement window (e.g., a period from time point tₙ₋₁ to time point tₙ) to generate at least one RRM measurement value, and may control the RRM prediction module 132 during the prediction window (e.g., a period from time point tₙ to time point tₙ₊₁) to generate at least one RRM prediction value based on the at least one RRM measurement value. Continuing to refer to FIG. 4, in the Nth cycle, the communication processor 131 may control the RRM measurement module 133 to measure RRM every first period in the measurement window (e.g., the period from time point tₙ₋₁ to time point tₙ) and to generate two RRM measurement values {yₙ₋₁, yₙ}. In the Nth cycle, the communication processor 131 may control the RRM prediction module 132 to predict RRM every second period in the prediction window (e.g., the period from time point tₙ to time point tₙ₊₁) and to generate K RRM prediction values {ŷ_{n,1}, ŷ_{n,2}, . . . , ŷ_{n,K}}. In an embodiment, the RRM prediction values {ŷ_{n,1}, ŷ_{n,2}, . . . , ŷ_{n,K}} may be generated by the RRM prediction module 132 based on the plurality of previously measured RRM measurement values. The first period for RRM measurement may represent the RRM measurement cycle, and the second period for RRM prediction may represent the RRM prediction cycle. In an embodiment, the first period may be longer than the second period. That is, the number of RRM prediction values generated in the Nth cycle may be greater than the number of RRM measurement values generated in the same Nth cycle. For example, assuming that in the Nth cycle, the time point tₙ₋₁ is 0 seconds, the first period (e.g., the RRM measurement cycle) may be 5 seconds, and the second period (e.g., the RRM prediction cycle) may be 1 second, the RRM measurement module 133 may generate RRM measurement values {yₙ₋₁, yₙ} at 0 and 5 seconds in the Nth cycle, respectively, and the RRM prediction module 132 may generate RRM prediction values {ŷ_{n,1}, ŷ_{n,2}, . . . , ŷ_{n,K}} at 6 seconds, 7 seconds, 8 seconds, 9 seconds, and 10 seconds in the Nth cycle, respectively. However, embodiments of the present disclosure are not limited thereto, and the RRM measurement module 133 may generate RRM measurement values with different periods and the RRM prediction module 132 may generate RRM prediction values with different periods.

In the (N+1)th cycle, the communication processor 131 may control the RRM measurement module 133 to measure RRM every first period in the measurement window (the period from time point tₙ to time point tₙ₊₁) and to generate two RRM measurement values {yₙ, yₙ₊₁}. In the (N+1)th cycle, the communication processor 131 may control the RRM prediction module 132 to predict RRM every second period in the prediction window (e.g., the period from time point tₙ₊₁ to time point tₙ₊₂) and to generate K RRM prediction values {ŷ_{n+1,1}, ŷ_{n+1,2}, . . . , ŷ_{n+1,K}}. In an embodiment, the RRM prediction values {ŷ_{n+1,1}, ŷ_{n+1,2}, . . . , ŷ_{n+1,K}} may be generated by the RRM prediction module 132 based on the plurality of previously measured RRM measurement values. The first period for RRM measurement may represent the RRM measurement cycle, and the second period for RRM prediction may represent the RRM prediction cycle. In an embodiment, the first period may be longer than the second period. That is, the number of RRM prediction values generated in the (N+1)th cycle may be greater than the number of RRM measurement values generated in the same (N+1)th cycle. For example, assuming that in the (N+1)th cycle, the time point tₙ is 5 seconds, the first period may be 5 seconds, and the second period may be 1 second, the RRM measurement module 133 may generate RRM measurement values {yₙ, yₙ₊₁} at 5 seconds and 10 seconds in the (N+1)th cycle, respectively, and the RRM prediction module 132 may generate RRM prediction values {ŷ_{n+1,1}, ŷ_{n+1,2}, . . . , ŷ_{n+1,K}} at 11 seconds, 12 seconds, 13 seconds, 14 seconds, and 15 seconds in the (N+1)th cycle, respectively. However, embodiments of the present disclosure are not limited thereto, and the RRM measurement module 133 may generate RRM measurement values with different periods and the RRM prediction module 132 may generate RRM prediction values with different periods.

The communication processor 131 may repeat the above-described operation whenever shifting the measurement window and the prediction window to obtain the plurality of RRM measurement values and the plurality of RRM prediction values (generated based on the plurality of RRM measurement values).

The communication processor 131 may compare the RRM measurement value yₙ₊₁ to the RRM prediction value ŷ_{n,K} generated at the same time point tₙ₊₁ based on a loss function, and may calculate a first difference value between the RRM measurement value yₙ₊₁ and the RRM prediction value ŷ_{n,K}. For example, the communication processor 131 may calculate the first difference value by comparing the RRM measurement value yₙ₊₁ generated in the measurement window (e.g., 10 seconds) of the (N+1)th cycle with the RRM prediction value ŷ_{n,K} generated in the prediction window (e.g., 10 seconds) of the Nth cycle. Similarly, the communication processor 131 may compare the RRM measurement value yₙ₊₂ with the RRM prediction value ŷ_{n+1,K} generated at the same time point tₙ₊₂ based on the loss function to calculate a second difference value between the RRM measurement value yₙ₊₂ and the RRM prediction value ŷ_{n+1,K}. For example, the communication processor 131 may calculate the second difference value by comparing the RRM measurement value yₙ₊₂ generated in the measurement window (e.g., 15 seconds) of an (N+2)th cycle with the RRM prediction value ŷ_{n+1,K} generated in the prediction window (e.g., 15 seconds) of the (N+1)th cycle. In an embodiment, the loss function may be based on at least one of an MSE, an RMSE, an MAE, or a Gaussian negative log-likelihood loss.

When calculating the first and second difference values, the communication processor 131 may additionally use at least one of a measurement value related to Doppler spread and shift measured by the receiver of the communication module 130, a measurement value related to timing advance and transmission power control measured by the transmitter of the communication module 130, or a sensing value of a gyroscopic sensor electrically connected to the communication module 130.

The communication processor 131 may select the RRM measurement value yₙ₊₁ as at least one target RRM measurement value according to whether the first difference value between the RRM measurement value yₙ₊₁ and the RRM prediction value ŷ_{n,K} satisfies a predetermined condition (e.g., the first threshold>the difference value>the second threshold). Similarly, the communication processor 131 may select the RRM measurement value yₙ₊₂ as at least one target RRM measurement value according to whether the second difference value between the RRM measurement value yₙ₊₂ and the RRM prediction value ŷ_{n+1,K} satisfies a predetermined condition (e.g., the first threshold>the difference value>the second threshold). For example, when the first difference value is less than the first threshold and greater than the second threshold, and the second difference value is greater than or equal to the first threshold, in an embodiment, the communication processor 131 may select the RRM measurement value yₙ₊₁ as at least one target RRM measurement value to store the RRM measurement value yₙ₊₁ in memory, and may delete the RRM measurement value yₙ₊₂ without storing the RRM measurement value yₙ₊₂ in memory. Accordingly, the communication processor 131 may update the RRM prediction module 132 based on reliable data (e.g., the RRM measurement value yₙ₊₁).

When the data size of at least one target RRM measurement value stored in the memory is greater than or equal to the third threshold, the communication processor 131 may update the RRM prediction module 132 based on the at least one target RRM measurement value stored in the memory. When the data size of at least one target RRM measurement value stored in the memory is less than the third threshold, the communication processor 131 may repeat the above-described operation until the data size is greater than or equal to the third threshold.

The communication processor 131 may delete a target RRM measurement value of which the storage period is greater than or equal to the fourth threshold from among at least one target RRM measurement value stored in the memory.

FIG. 5 is a flowchart illustrating a method of operating a communication module, according to an embodiment.

Referring to FIG. 5, the method S500 of operating the communication module 130 for adaptively updating the RRM prediction module 132 in the wireless communication system 10 may include operations S110 to S130. The communication module 130, the communication processor 131, the RRM prediction module 132, the RRM measurement module 133, and the memory 134 of FIGS. 5 to 7 may respectively correspond to the communication module 130, the communication processor 131, the RRM prediction module 132, the RRM measurement module 133, and the memory 134 of FIG. 3.

In operation S110, the communication processor 131 of the communication module 130 may control the RRM measurement module 133 to measure RRM every first period and to generate the plurality of RRM measurement values. In an embodiment, the first period may be longer than the second period. That is, the RRM measurement period may be longer than the RRM prediction period. For example, the number of RRM measurements measured over a period T may be less than the number of RRM predictions predicted over the same period T.

In operation S120, the communication processor 131 of the communication module 130 may control the RRM prediction module 132 to predict RRM every second period and to generate the plurality of RRM prediction values. For example, the communication processor 131 may predict the RRM of a next period based on the plurality of RRM measurement values measured in a previous period to generate the plurality of RRM prediction values for each second period. The RRM may include at least one of an RSRP, an RSRQ, an RSSI, or an SINR. However, embodiments of the present disclosure are not limited thereto, and the RRM, according to an embodiment, may include various RRM measurement values (or RRM measurement metrics) that may be obtained in the wireless communication system 10.

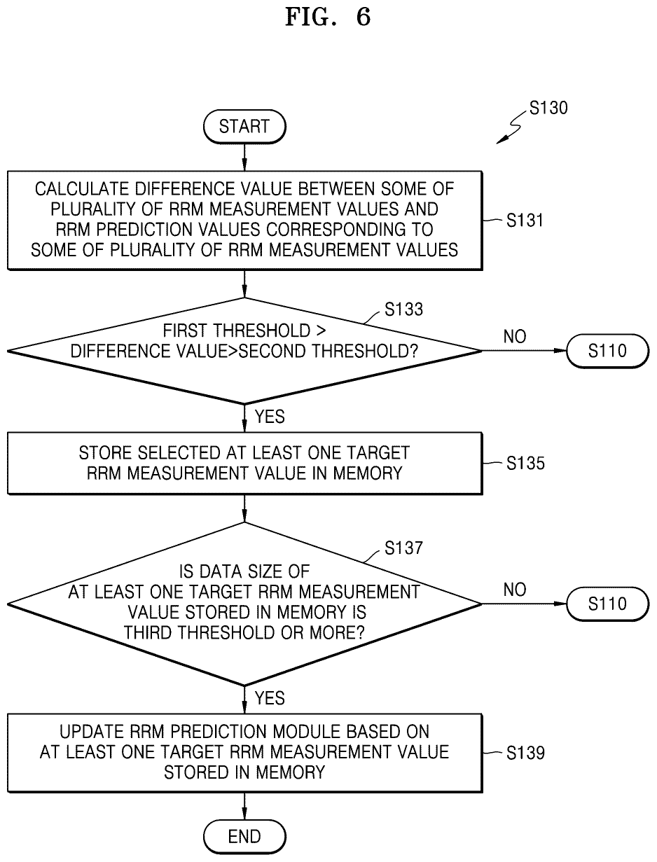

In operation S130, the communication processor 131 of the communication module 130 may update the RRM prediction module based on at least one target RRM measurement value selected from the plurality of RRM measurement values. Operation S130 is further described with reference to FIG. 6.

The communication module 130, according to an embodiment, may adaptively update the RRM prediction module 132 (e.g., the AI model included in the RRM prediction module 132) by reflecting changes in the internal/external environments of the electronic device (e.g., the first electronic device 100 or the second electronic device 300).

FIG. 6 is a flowchart illustrating a method of operating a communication module, according to an embodiment.

Referring to FIG. 6, operation S130 of FIG. 5 may include operations S131 to S139. Descriptions of operations S131 to S139 that may be substantially similar and/or the same as descriptions of operations S110 to S130 described above with reference to FIG. 5 may be omitted for the sake of brevity.

In operation S131, the communication processor 131 of the communication module 130 may calculate a difference value between some of the plurality of RRM measurement values and RRM prediction values corresponding to the some of the plurality of RRM measurement values. In an embodiment, some RRM prediction values may be RRM prediction values corresponding to the some of the plurality of RRM prediction values. The communication processor 131 may calculate the difference value by using the loss function based on at least one of an MSE, an RMSE, an MAE, or a Gaussian negative log-likelihood loss. The communication processor 131 may calculate the difference value by additionally using at least one of a measurement value related to Doppler spread and shift measured by the receiver of the communication module 130, a measurement value related to timing advance and transmission power control (e.g., a transmission power control command) measured by the transmitter of the communication module 130, or a sensing value of a gyroscopic sensor electrically connected to the communication module 130 as well as the loss function.

In operation S133, the communication processor 131 may determine whether a difference value between some of the plurality of RRM measurement values and RRM prediction values corresponding to some of the plurality of RRM measurement values is less than the first threshold and greater than the second threshold. In an embodiment, whether the difference value is less than the first threshold and greater than the second threshold may be a predetermined condition for selecting at least one target RRM measurement value. In an embodiment, the first and second thresholds may be determined in advance as hyper-parameters. However, embodiments of the present disclosure are not limited thereto. For example, the first and second thresholds may be adaptively changed according to the wireless communication environment. The communication processor 131 may use a predetermined condition based on one of the first to second thresholds according to the wireless communication environment. The communication processor 131 may perform operation S135 when the difference value is less than the first threshold and greater than the second threshold (e.g., first threshold>difference value>second threshold) (YES at operation S133). The communication processor 131 may perform again the remaining operations starting from operation S110 when the difference value is greater than or equal to the first threshold or the difference value is less than or equal to the second threshold (e.g., when first threshold≥difference value or difference value≤second threshold) (NO at operation S133).

In operation S135, the communication processor 131 may store at least one selected target RRM measurement value in the memory 134. For example, the communication processor 131 may store only at least one target RRM measurement value selected from the plurality of RRM measurement values in the memory 134, in order to update the RRM prediction module 132 based on reliable data (e.g., at least one target RRM measurement value) by storing only at least one target RRM measurement value satisfying a predetermined condition.

In operation S137, the communication processor 131 may determine whether the data size of at least one target RRM measurement value stored in the memory 134 is greater than or equal to the third threshold. The communication processor 131 may perform operation S139 when the data size of the at least one target RRM measurement value stored in the memory 134 is greater than or equal to the third threshold (YES at operation S137). The communication processor 131 may perform again the remaining operations starting from operation S110 when the data size of the at least one target RRM measurement value stored in the memory 134 is less than the third threshold (NO at operation S137). In an embodiment, rather than updating the RRM prediction module 132 whenever a target RRM measurement value is selected, when the RRM prediction module 132 is updated by accumulating the target RRM measurement value to a certain size or more (e.g., the third threshold or more), learning stability of the AI model included in the RRM prediction module 132 may be improved.

In operation S139, the communication processor 131 may update the RRM prediction module 132 based on the at least one target RRM measurement value stored in the memory 134.

The communication module 130, according to an embodiment, may adaptively update the RRM prediction module 132 based on reliable data (e.g., at least one target RRM measurement value) to reflect changes in the internal/external environments of the electronic device 100 when predicting RRM and to generate a more accurate RRM prediction value, when compared to a related communication module.

Furthermore, the communication module 130, according to an embodiment, may shorten the measurement cycle of the RRM measurement module 133 based on an accurate RRM prediction value to reduce power consumption for RRM measurement and to prevent excessive system overhead occurring during RRM measurement and to improve communication performance of the electronic device 100, when compared to a related communication module.

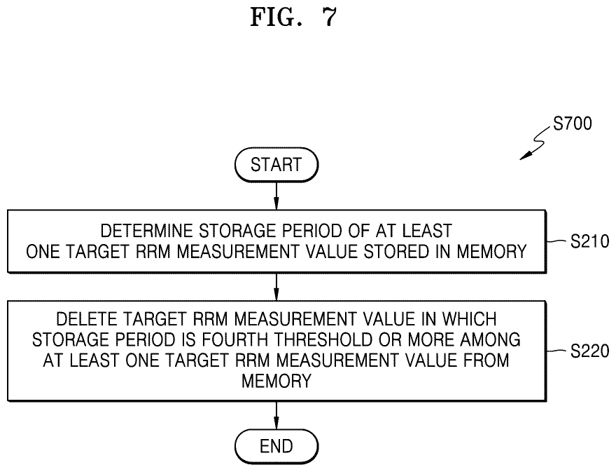

FIG. 7 is a flowchart illustrating a method of operating a communication module, according to an embodiment.

Referring to FIG. 7, the method S700 of operating the communication module 130 for adaptively updating the RRM prediction module 132 in the wireless communication system may include operations S210 to S220. Descriptions of operations S210 to S220 that may be substantially similar and/or the same as the descriptions of operations described above with reference to FIGS. 5 and 6 may be omitted for the sake of brevity.

In operation S210, the communication processor 131 of the communication module 130 may determine a storage period of at least one target RRM measurement value stored in the memory 134. As used herein, the storage period may refer to the total period in which the target RRM measurement value is stored in the memory 134.

In operation S220, the communication processor 131 may delete a target RRM measurement value of which the storage period is greater than or equal to the fourth threshold from among at least one target RRM measurement value. In an embodiment, the fourth threshold may be determined in advance as a hyper-parameter. However, embodiments of the present disclosure are not limited thereto. For example, the fourth threshold may be adaptively changed according to the wireless communication environment. In addition, the fourth threshold may be a value set in a flushing timer of the communication processor 131. Because each of at least one target RRM measurement value simulates the wireless communication environment or channel environment at the time each of at least one target RRM measurement value is stored in the memory 134, the longer the storage period, the less likely it is that the target RRM measurement value may accurately simulate the current wireless communication environment or channel environment. That is, the longer the storage period of the target RRM measurement value, the less reliable the target RRM measurement value may be.

Therefore, the communication module 130, according to an embodiment, may delete an old RRM measurement value from among the at least one target RRM measurement value stored in the memory 134 to update the RRM prediction module 132 based on a target RRM measurement value (e.g., relatively high-reliability data) reflecting the current wireless communication environment or channel environment.

FIG. 8 is a block diagram illustrating an electronic device 1500, according to an embodiment.

Referring to FIG. 8, the electronic device 1500 may include memory 1010, a processor 1020, an input/output controller 1040, a display 1050, an input device 1060, and a communication processing unit 1090. In an embodiment, the memory 1010 may include a plurality of memories 1010. The electronic device 1500, the communication processing unit 1090, an RRM prediction module 1091a, and an RRM measurement module 1093 of FIG. 8 may include and/or may be similar in many respects to the electronic device 100, the communication module 130, the RRM prediction module 132, and the RRM measurement module 133 described above with reference to FIGS. 1 to 7, and may include additional features not mentioned above. Furthermore, the processor 1022 of FIG. 8 may include and/or may be similar in many respects to the communication processor 131 of FIGS. 1 to 7. Consequently, repeated descriptions described above with reference to FIGS. 1 to 7 may be omitted for the sake of brevity.

Referring to FIG. 8, the memory 1010 may include a program storage unit 1011 storing a program for controlling the operation of the electronic device 1500 and a data storage unit 1012 storing data generated during program execution. The data storage unit 1012 may store data necessary for an operation of an application program 1013. For example, the data storage unit 1012 may store at least one target RRM measurement value for updating the RRM prediction module 1091a. The program storage unit 1011 may include the application program 1013. As used herein, the program included in the program storage unit 1011 may be expressed as an instruction set and/or as a collection of instructions. The application program 1013 may include an application program operating in the electronic device 1500. That is, the application program 1013 may include an instruction of an application driven by the processor 1022. FIG. 8 illustrates a case in which the RRM prediction module 1091a including an AI model for RRM prediction is located outside the communication processing unit 1090 (e.g., included in the processor 1022). However, embodiments of the present disclosure are not limited thereto, and the RRM prediction module 1091a including the AI model, according to an embodiment, may be included in various configurations of the electronic device 1500 according to design constraints.

According to an embodiment, the processor 1022 may control the RRM prediction module 1091a to predict RRM and to generate a plurality of RRM prediction values, may control the RRM measurement module 1093 to measure RRM and to generate a plurality of RRM measurement values, may select at least one target RRM measurement value based on a loss function for the plurality of RRM measurement values and the plurality of RRM prediction values, may store at least one target RRM measurement value in the memory 1010, and may update the RRM prediction module 1091a based on the at least one target RRM measurement value stored in the memory 1010.

According to an embodiment, the processor 1022 may calculate a difference value between some of the plurality of RRM measurement values and RRM prediction values corresponding to some of the plurality of RRM measurement values based on the loss function, and may select an RRM measurement value in which the difference value is less than the first threshold and greater than the second threshold from the plurality of RRM measurement values as at least one target RRM measurement value.

According to an embodiment, the processor 1022 may identify the data size of the at least one target RRM measurement value, and when the data size is greater than or equal to the third threshold, may update the RRM prediction module 1091a based on the at least one target RRM measurement value stored in the memory 1010, and when the data size is less than the third threshold, may repeat operation of selecting at least one target RRM measurement value and storing the at least one target RRM measurement value in the memory 1010 until the data size becomes the third threshold.

According to an embodiment, the processor 1022 may identify a storage period of the at least one target RRM measurement value stored in the memory 1010, and may delete, from the memory 1010, a target RRM measurement value of which the storage period is greater than or equal to the fourth threshold from among the at least one target RRM measurement value.

Therefore, the electronic device 1500, according to an embodiment, may adaptively update the RRM prediction module 1091a by reflecting changes in the internal/external environments of the electronic device 1500 to improve accuracy of the RRM prediction value.

Furthermore, the electronic device 1500 may reduce the use of wireless communication resources required for RRM measurement and to prevent excessive system overhead, thereby improving the communication performance of the electronic device 1500.

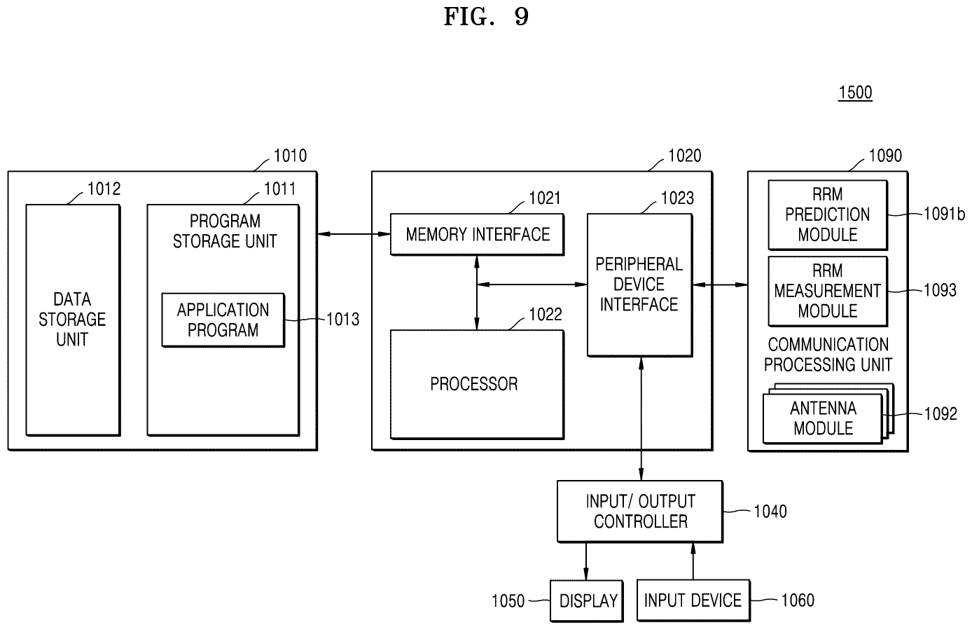

FIG. 9 is a block diagram illustrating an alternate configuration of the electronic device 1500 of FIG. 8, according to an embodiment.

Referring to FIG. 9, the electronic device 1500 of FIG. 9 may include and/or may be similar in many respects to the electronic device 1500 described above with reference to FIG. 8, and may include additional features not mentioned above. Consequently, repeated descriptions of the electronic device 1500 described above with reference to FIG. 8 may be omitted for the sake of brevity.

Although FIG. 8 shows that the RRM prediction module 1091a is included in the processor 1022, the present disclosure is not limited thereto, and the RRM prediction module 1091b, according to an embodiment, may be included in various configurations of the electronic device 1500 according to design constraints. For example, as shown in FIG. 9, the RRM prediction module 1091b including an AI model for RRM prediction, according to an embodiment, may be included in the communication processing unit 1090.

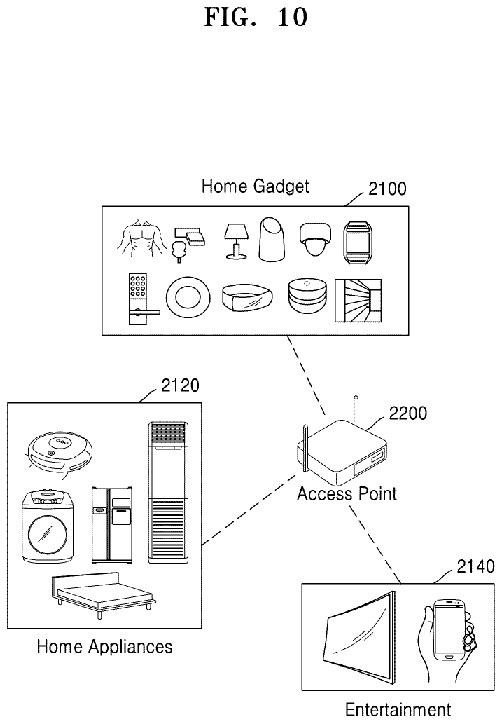

FIG. 10 is a diagram illustrating an example of electronic devices to which an embodiment is applied.

Referring to FIG. 10, a home gadget 2100, a home appliance 2120, and an entertainment device 2140 may be and/or may include electronic devices capable of performing wireless communication connections based on AI and/or machine learning. In an embodiment, an AP 2200 may establish wireless communication connections by using AI and/or machine learning-based communication technology with at least one of the electronic devices (e.g., the home gadget 2100, the home appliance 2120, and/or the entertainment device 2140).

As shown in FIG. 10, each electronic device (e.g., the home gadget 2100, the home appliance 2120, the entertainment device 2140), according to embodiments, may include an AI model for RRM prediction for each device in order to stably perform wireless communication connection with an external electronic device (e.g., the AP 2200). Each electronic device may generate RRM prediction values based on previously measured RRM measurement values by using an AI model, and may update the AI model by using at least one target RRM measurement value (e.g., a reliable RRM measurement value) satisfying a predetermined condition from among the RRM measurement values.

The electronic devices (e.g., the home gadget 2100, the home appliance 2120, the entertainment device 2140), according to embodiments, may adaptively update the AI model for RRM prediction by reflecting changes in the internal/external environments of the electronic device.

While the present disclosure has been particularly shown and described with reference to embodiments thereof, it is to be understood that various changes in form and details may be made therein without departing from the spirit and scope of the following claims.

What is claimed is:

1. A communication module comprising:
a radio resource management (RRM) measurer configured to:
measure a first RRM value of a first period, and
generate a plurality of RRM measurement values comprising the first RRM value of the first period;
an RRM predictor configured to:
predict a second RRM value of a second period, based on the plurality of RRM measurement values, and
generate a plurality of RRM prediction values comprising the second RRM value of the second period;
one or more communication processors comprising processing circuitry; and
a memory storing instructions,
wherein the instructions, when executed by the one or more communication processors individually or collectively, cause the communication module to:
select at least one target RRM measurement value from among the plurality of RRM measurement values; and
update the RRM predictor based on the at least one target RRM measurement value.

2. The communication module of claim 1, wherein the first RRM value and the second RRM value comprise at least one of a reference signal received power (RSRP), a reference signal received quality (RSRQ), a received signal strength indicator (RSSI), or a signal-to-interference-plus-noise ratio (SINR).

3. The communication module of claim 1, wherein the instructions, when executed by the one or more communication processors individually or collectively, further cause the communication module to:
determine a difference value between one or more of the plurality of RRM measurement values and one or more of the plurality of RRM prediction values corresponding to the one or more of the plurality of RRM measurement values;
select, from among the one or more of the plurality of RRM measurement values, the at least one target RRM measurement value in which the difference value is less than a first threshold and greater than a second threshold; and
store the at least one target RRM measurement value in the memory.

4. The communication module of claim 3, wherein the instructions, when executed by the one or more communication processors individually or collectively, further cause the communication module to:
determine whether a data size of the at least one target RRM measurement value stored in the memory is greater than or equal to a third threshold; and
update, based on the data size being greater than or equal to the third threshold, the RRM predictor using the at least one target RRM measurement value stored in the memory.

5. The communication module of claim 3, wherein the instructions, when executed by the one or more communication processors individually or collectively, further cause the communication module to:
determine a storage period of the at least one target RRM measurement value stored in the memory; and
delete, from the memory, a target RRM measurement value from among the at least one target RRM measurement value having a corresponding storage period that is greater than or equal to a fourth threshold.

6. The communication module of claim 3, further comprising:
a receiver configured to measure a receive measurement value related to Doppler spread and shift;
a transmitter configured to measure a transmit measurement value related to timing advance and transmission power control; and
a gyroscopic sensor coupled with the communication module and configured to measure a sensing value,
wherein the instructions, when executed by the one or more communication processors individually or collectively, further cause the communication module to:
determine the difference value between the one or more of the plurality of RRM measurement values and the one or more of the plurality of RRM prediction values corresponding to the one or more of the plurality of RRM measurement values, based on at least one of the receive measurement value, the transmit measurement value, or the sensing value.

7. The communication module of claim 3, wherein the instructions, when executed by the one or more communication processors individually or collectively, further cause the communication module to:
determine the difference value between the one or more of the plurality of RRM measurement values and the one or more of the plurality of RRM prediction values corresponding to the one or more of the plurality of RRM measurement values, based on a loss function based on at least one of a mean squared error (MSE), a root mean squared error (RMSE), a mean absolute error (MAE), or a Gaussian negative log-likelihood loss.

8. The communication module of claim 1, wherein the first period is longer than the second period.

9. A method of operating a communication module, the method comprising:
generating a plurality of radio resource management (RRM) measurement values by measuring RRM values of first periods;
generating a plurality of RRM prediction values by predicting RRM values of second periods corresponding to the plurality of RRM measurement values;
selecting at least one target RRM measurement value from among the plurality of RRM measurement values; and
updating an RRM predictor based on the at least one target RRM measurement value.

10. The method of claim 9, wherein each of the plurality of RRM measurement values comprises at least one of a reference signal received power (RSRP), a reference signal received quality (RSRQ), a received signal strength indicator (RSSI), or a signal-to-interference-plus-noise ratio (SINR).

11. The method of claim 9, wherein the updating of the RRM predictor comprises:
determining a difference value between one or more of the plurality of RRM measurement values and one or more of the plurality of RRM prediction values corresponding to the one or more of the plurality of RRM measurement values;
selecting, from among the one or more of the plurality of RRM measurement values, the at least one target RRM measurement value in which the difference value is less than a first threshold and greater than a second threshold; and
storing the at least one target RRM measurement value in a memory.

12. The method of claim 11, wherein the updating of the RRM predictor further comprises:
determining whether a data size of the at least one target RRM measurement value stored in the memory is greater than or equal to a third threshold; and
updating, based on the data size being greater than or equal to the third threshold, the RRM predictor using the at least one target RRM measurement value stored in the memory.

13. The method of claim 11, further comprising:
determining a storage period of the at least one target RRM measurement value stored in the memory; and
deleting, from the memory, a target RRM measurement value from among the at least one target RRM measurement value having a corresponding storage period that is greater than or equal to a fourth threshold.

14. The method of claim 9, wherein the generating of the plurality of RRM prediction values comprises:
generating the plurality of RRM prediction values based on at least one of a receive measurement value related to Doppler spread and shift measured by a receiver of the communication module, a transmit measurement value related to timing advance and transmission power control measured by a transmitter of the communication module, or a sensing value measured by a gyroscopic sensor coupled with the communication module.

15. The method of claim 11, wherein the calculating of the difference value comprises:
determining the difference value between the one or more of the plurality of RRM measurement values and the plurality of RRM prediction values corresponding to the one or more of the plurality of RRM measurement values based on a loss function based on at least one of a mean squared error (MSE), a root mean squared error (RMSE), a mean absolute error (MAE), or a Gaussian negative log-likelihood loss.

16. The method of claim 9, wherein each of the first periods is longer than each of the second periods.

17. An electronic device comprising:
a communication module comprising a radio resource management (RRM) measurer;
memory storing instructions; and
one or more processors comprising an RRM predictor,
wherein the instructions, when executed by the one or more processors individually or collectively, cause the electronic device to:
measure, using the RRM measurer, a first RRM measurement value;
generate a plurality of RRM measurement values comprising the first RRM measurement value,
predict, using the RRM predictor, a plurality of RRM prediction values based on the plurality of RRM measurement values;
select at least one target RRM measurement value from among the plurality of RRM measurement values, based on a loss function for the plurality of RRM measurement values and the plurality of RRM prediction values;
store the at least one target RRM measurement value in the memory; and
update the RRM predictor based on the at least one target RRM measurement value stored in the memory.

18. The electronic device of claim 17, wherein the instructions, when executed by the one or more processors individually or collectively, further cause the electronic device to:
determine, based on the loss function, a difference value between one or more of the plurality of RRM measurement values and one or more of the plurality of RRM prediction values corresponding to the one or more of the plurality of RRM measurement values; and
select, from among the one or more of the plurality of RRM measurement values, the at least one target RRM measurement value in which the difference value is less than a first threshold and greater than a second threshold.

19. The electronic device of claim 17, wherein the instructions, when executed by the one or more processors individually or collectively, further cause the electronic device to:
determine a data size of the at least one target RRM measurement value;
update, based on the data size being greater than or equal to a third threshold, the RRM predictor using the at least one target RRM measurement value stored in the memory; and
based on the data size being less than the third threshold, repeat the selecting of the at least one target RRM measurement value and the storing of the at least one target RRM measurement value in the memory until the data size is greater than or equal the third threshold.

20. The electronic device of claim 17, wherein the instructions, when executed by the one or more processors individually or collectively, further cause the electronic device to:
determine a storage period of the at least one target RRM measurement value stored in the memory, and
delete, from the memory, a target RRM measurement value from among the at least one target RRM measurement value having a corresponding storage period that is greater than or equal to a fourth threshold.
